(19) United States
(12) Patent Application Publication
(10) Pub. No.: US 2023/0009005 A1
(43) Pub. Date: Jan. 12, 2023

(54) WASTE-CUTTING DEVICE AND METHOD FOR CUTTING UP PUNCHING SCRAP

(71) Applicant: Feintool International Holding AG, Lyss (CH)

(72) Inventors: Andreas WALTHER, Laupen (CH); Marc Staempeli, Lyss (CH)

(21) Appl. No.: 17/748,131

(22) Filed: May 19, 2022

(30) Foreign Application Priority Data
Jul. 6, 2021 (EP) 21183896.6

(51) Int. Cl. B02C 18/00; B02C 18/18

(52) U.S. Cl. CPC B02C 18/0092; B02C 18/18

(57) ABSTRACT

The invention relates to a method for cutting up punching scrap running as waste from a punching device, in particular from a fine blanking press, by means of a waste-cutting device, in particular which is arranged as a progressive tool with respect to the punching device, wherein, by way of the waste-cutting device, the punching scrap is completely cut through perpendicularly to the running direction thereof at a cutting edge by a cutting knife and in this way punching-scrap portions are formed, wherein, together with the stroke of the cutting knife, at least one scrap web of the punching scrap that is spaced apart from the punching-scrap boundaries is cut through by at least one punch which is spaced apart from the cutting knife, preferably by at least two punches, in particular so that each punching-scrap portion is subdivided into at least two punching-scrap sub-portions. The invention also relates to a waste-cutting device of a punching device, comprising a cutting knife and a cutting edge, wherein, by way of the interaction of cutting knife and cutting edge during a stroke of the cutting knife, punching scrap which can be passed through between cutting knife and cutting edge in a running direction can be completely cut through perpendicularly to the running direction, in which, spaced apart from the cutting knife, provision is made of at least one punch which is arranged in a locationally fixed manner with respect to the cutting knife and which can be moved together with the cutting knife, in particular by way of which at least one scrap web of the punching scrap can be cut through in the punching scrap.

The invention relates to a method for cutting up punching scrap running as waste from a punching device by means of a waste-cutting device, wherein, by way of the waste-cutting device, the punching scrap is completely cut through perpendicularly to the running direction thereof at a cutting edge by a cutting knife and in this way punching-scrap portions are formed.

The invention also relates to a waste-cutting device of a punching device, comprising a cutting knife and a cutting edge, wherein, by way of the interaction of cutting knife and cutting edge during a stroke of the cutting knife, punching scrap which can be passed through between cutting knife and cutting edge in a running direction can be completely cut through perpendicularly to the running direction.

A punching device may be designed for example as a press in which, during a so-called trim-in-place process, one sheet-metal piece or multiple sheet-metal pieces are punched out of a metal sheet per stroke. A punching device may, for example, also be designed as a so-called fine blanking press, in which, before the blanking process, the sheet-metal piece to be blanked/punched, by contrast to normal punching, is held firmly along the cutting contour by means of a so-called V-ring. In this application too, one sheet-metal piece or multiple sheet-metal pieces can be punched out of a metal sheet per stroke.

The remainder of the metal sheet from which the sheet-metal pieces have been punched out/cut out comprises a multiplicity of cutouts which, in terms of contour, normally correspond to the negative of the in each case punched-out sheet-metal piece. The technical term by which this metal-sheet remainder is referred to is punching scrap. In such punching scrap, the cutouts are connected to one another by webs such that the punching scrap forms a coherent strip in a manner corresponding to the original metal sheet.

The punching scrap is normally waste that can be disposed of or recycled.

It is basically known for the punching scrap running from a punching device to be completely cut through in a direction perpendicular to the strip-running direction, in order in this way for punching-scrap portions to be formed in each case.

For this cutting-through action, use is made of the waste-cutting device mentioned in the introduction, which is arranged for example as a so-called progressive tool after the punching device in the strip-running direction. After the cutting-through, provision may be made for the punching-scrap portions, which in each case have the full, original metal-sheet width as viewed perpendicularly to the strip-running direction, to fall into a waste container.

A problem here is that the punching-scrap portions can fall into the waste container in a disorderly manner and snagging of webs and cutouts cut open in this case can occur. Particularly owing to the full width of the punching-scrap portions, these are therefore unable to achieve a high packing density in the waste container. The degree of filling of a waste container is therefore frequently very low, and it has to be emptied or exchanged frequently.

Against this background, it is an object of the invention to achieve improved break-up of the punching-scrap portions, in particular in order in this way to increase the degree of filling of waste containers.

According to the invention, this is achieved in the case of a method of the type mentioned in the introduction in that, together with the stroke of the cutting knife, at least one scrap web of the punching scrap that is spaced apart from the punching-scrap boundaries is cut through by at least one punch which is spaced apart from the cutting knife.

Furthermore, according to the invention, the object is achieved in the case of a waste-cutting device of the type mentioned in the introduction in that, spaced apart from the cutting knife, provision is made of at least one punch which is arranged in a locationally fixed manner with respect to the cutting knife and which can be moved together with the cutting knife, in particular by way of which at least one scrap web of the punching scrap can be cut through in the punching scrap.

The cutting knife, which performs the complete cutting-through action in the transverse direction, that is to say perpendicularly to the strip-running direction, is, in its direction of extent, preferably oriented perpendicularly to the strip-running direction. In this case, the at least one punch is spaced apart from the cutting knife in the running direction/perpendicularly to the direction of extent of the cutting knife.

Preferably, it may be provided that, by way at least two punches or by way of at least three punches, a number of scrap webs spaced apart from the punching-scrap boundary that corresponds to the number of punches are cut through. For example, the at least two punches, in particular all the punches, of the waste-cutting device may be are arranged on a common punch support, in particular which extends parallel to the cutting knife at a distance therefrom.

By virtue of the cutting-open of at least one scrap web arranged spaced apart from the punching-scrap boundary, that is to say situated within the punching-scrap area, in addition to the complete cut in the transverse direction (perpendicular to the strip-running direction), it is possible to realize a further subdivision of each punching-scrap portion in the transverse direction.

It may be provided that each punching-scrap portion is reduced in this way to at least two sub-portions. In this way, a higher packing density in the waste container can evidently be achieved. Also, in this way, disposal or recycling is facilitated.

Preferably, it may be provided that the punching-scrap portion is reduced to a number of sub-portions that corresponds to the number of punches plus 1.

Preferably, it is provided that a respective punch is arranged in such a way that, by way of said punch, in each case cutting-though is realized for a scrap web whose cutting-through, in conjunction with the complete separating cut in the transverse direction, also results in complete cutting-through of the in each case produced punching-scrap portion in the longitudinal direction, in particular at the width position of the in each case considered punch. Here, the width position is to be understood as meaning the position of the punch relative to the punching scrap perpendicular to the strip-running direction.

Particularly preferably, provision may be made of at least two punches which are arranged spaced apart from one another in the direction of extent of the cutting knife. The punches may preferably each also be arranged, in the direction of extent of the cutting knife, spaced apart from the cutting-knife ends, which are situated oppositely in the direction of extent.

Furthermore preferably, it may be provided that, of the at least two punches, preferably of at least three punches, at least one of the punches is at a different distance, in particular as viewed in the strip-running direction, from the cutting knife than at least one other punch. Multiple punches may consequently be offset from one another in the strip-running direction, in particular so that the punches, in terms of their position, can in each case also be adapted particularly easily to the position of scrap webs of the punching scrap, in particular since it is often the case that, for a high yield, the cutouts in the punching scrap are likewise situated offset from one another.

The invention may preferably provide that, in successive strokes, firstly the at least one scrap web is cut through, preferably in each case one scrap web is cut through by each punch, and subsequently the punching scrap is completely cut through perpendicularly to the running direction by the cutting knife.

Preferably, it is provided that the at least one punch is arranged before the cutting knife in the intended strip-running direction.

Although, after the cutting-through of the at least one scrap web, the punching scrap is already cut open within its punching-scrap area, it still has cohesion in the transverse direction, in particular via scrap webs at the boundary of the punching scrap. Said cohesion is eliminated only subsequently by the separating cut in the transverse direction. Consequently, only with the separating cut is the punching-scrap portion formed and is the latter subdivided into the sub-portions directly with the separating cut.

In all possible embodiments, it may furthermore be provided that the waste-cutting device is driven directly by an associated punching device, the produced punching scrap of which is to be cut into pieces. By way of a preferably provided direct kinematic coupling between punching device and waste-cutting device, with each stroke that effects a punching action in the punching device, a stroke in the waste-cutting device that produces a cutting action by the at least one punch and the cutting knife can be produced. A separate drive for the waste-cutting device can thus also be saved. It is nevertheless also possible for the waste-cutting device to have a separate drive, for example which runs synchronized with a punching device.

The invention may provide that the cutting-open of the at least one scrap web is realized by a shearing action, in particular as is also realized by the cutting knife.

Preferably, it is provided by contrast that a piece is punched out of the at least one scrap web by the at least one punch, in particular during a trim-in-place process. This has the advantage that the punching scrap, with its remaining parts, remains within the original plane of the metal sheet and, in this way, the further running of the punching scrap is not impaired. The punched-out piece can fall downwards from the waste-cutting device through a die opening, which interacts with the respective punch, and be collected, for example fall into the same waste container into which the punching-scrap portions also fall.

A structurally particularly preferred embodiment may provide that the waste-cutting device comprises a lower support and comprises an upper support, in particular which can be coupled kinematically to a punching device by way of which a stroke movement relative to the lower support can be performed, and comprises an exchangeable punching module comprising a knife unit, which is or at least can be connected to the upper support and on which the cutting knife and the at least one punch are arranged, and comprising a cutting plate, which is or at least can be connected to the lower support and on which a cutting edge, which interacts with the cutting knife, and at least one die opening, which interacts with the at least one punch, are arranged.

In this way, it is possible to achieve a modular construction, in particular which makes possible quick and favourable adaptation of the punching module if the punching scrap changes.

Preferably, it may be provided that the knife unit and the upper support have interacting rail elements by means of which the knife unit, preferably in the running direction of punching scrap or perpendicularly to the direction of extent of the cutting knife, is or at least can be pushed into the upper support.

It is preferably additionally possible for provision to be made of a middle support, on which a slotted guide of the punching module is or at least can be fastened, through which slotted guide the cutting knife and the at least one punch or the common punch support can be guided.

Since, for interaction, the knife unit and the cutting plate of such a module must have a defined relative position with respect to one another, the invention may preferably provide that the fitting of the punching module in the waste-cutting device is realized by way of at least one punching-module support, by way of which the elements of the punching module, at least temporarily, in particular for fitting purposes, are/can be positioned, preferably are or at least can be fastened, in a locationally fixed manner relative to one another, and by way of which the punching module can, as a whole as a unit, be inserted into the waste-cutting device and be removed therefrom. By way of the at least one punching-module support, preferably by way of two spaced-apart punching-module supports, it is possible for the relative position between knife unit and cutting plate to be reliably maintained during the fitting in the waste-cutting device, so that, with fitted punching-module support, the fastening of knife unit and cutting plate, possibly also of slotted guide, can be realized. It may preferably be provided that the at least one punching-module support is removed only after fastening of the punching module on/in the waste-cutting device.

The insertion of a punching module in the waste-cutting device may preferably further be facilitated if the said waste-cutting device comprises two spaced-apart placement brackets on which the punching module can be placed and displaced. Such placement brackets may be arranged removably on the waste-cutting device and/or preferably arranged above a waste slide, in particular below a covering hood.

The at least one placement bracket may be arranged on the waste-cutting device in such a way that, after placement of a punching module, the interacting rail elements on the upper support and on the knife unit are oriented in alignment with one another such that a displacement of the punching module, in particular by means of the at least one punching-module support, on the at least one placement bracket brings about a connection of the rail elements.

Furthermore, it may preferably be provided that the upper support of the waste-cutting device has two spaced-apart guide channels by means of which the upper support can be pushed onto respective guide rods of a punching device. Such guide rods advantageously extend, just like the respective guide rod, in the strip-running direction and are spaced apart from one another perpendicularly to the strip-running direction. The guide rods allow the stroke movement of a punching device to be transmitted to the support.

Furthermore, the connection of waste-cutting device and punching device via guide rods received in channels gives rise to the particularly simple possibility of being able to variably set the distance between the waste-cutting device and the punching device by way of displacement of the upper support on the guide rods. In this way, the position of the separating cut realized in the transverse direction can be adapted particularly well to the pattern of the cutouts in the punching scrap, in particular in order to cut this at a location with a particularly small proportion of material.

A preferred embodiment of the waste-cutting device and of the method will be described in more detail on the basis of the following figures.

The figures show a waste-cutting device 1, which is arranged as a progressive tool after a punching device 3 (shown only in part) in the strip-running direction 2.

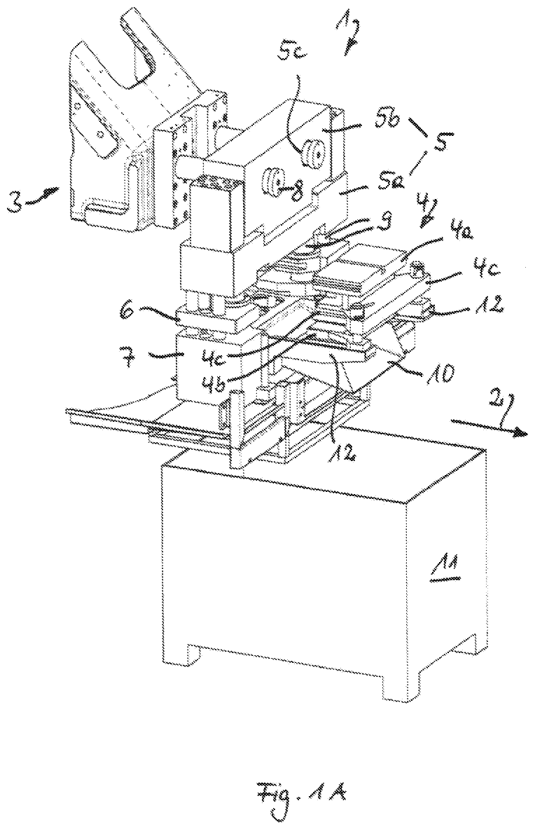

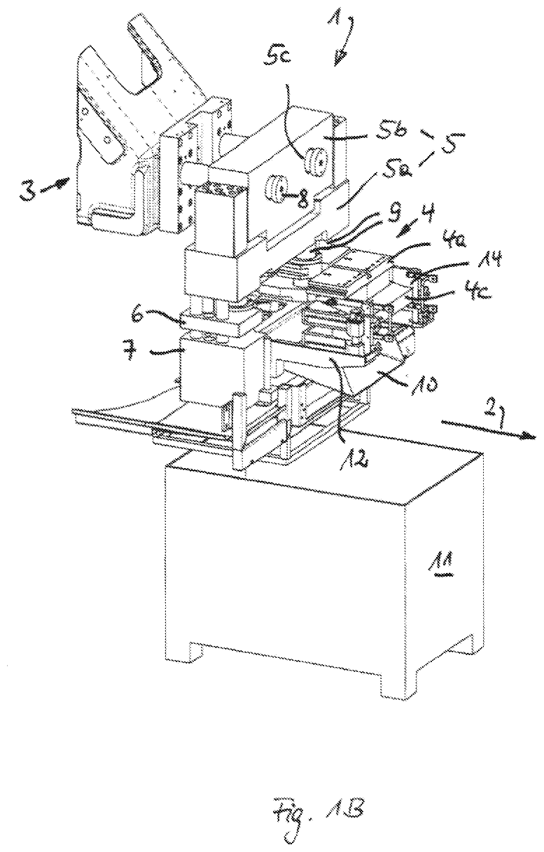

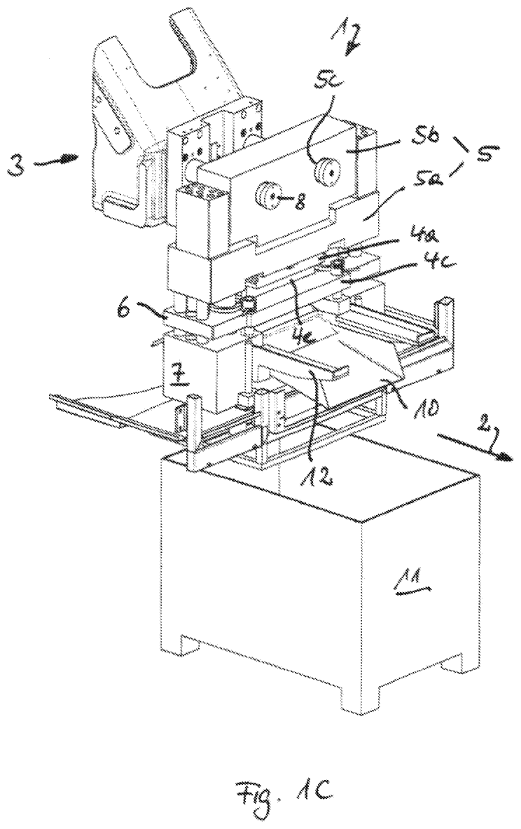

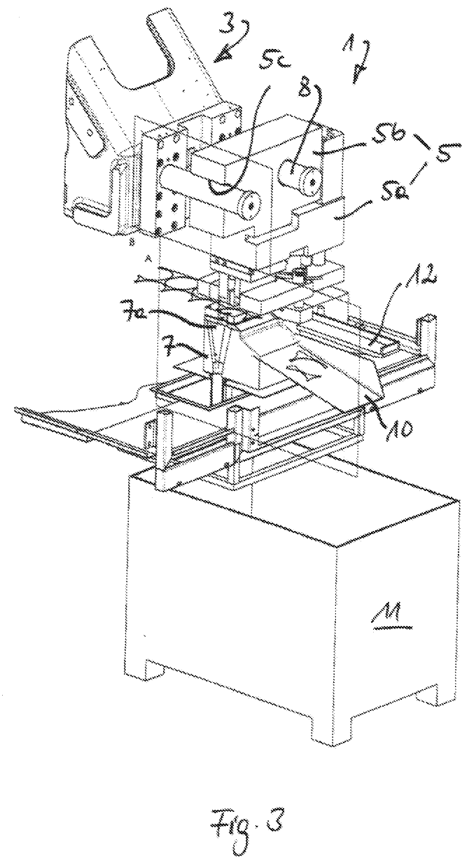

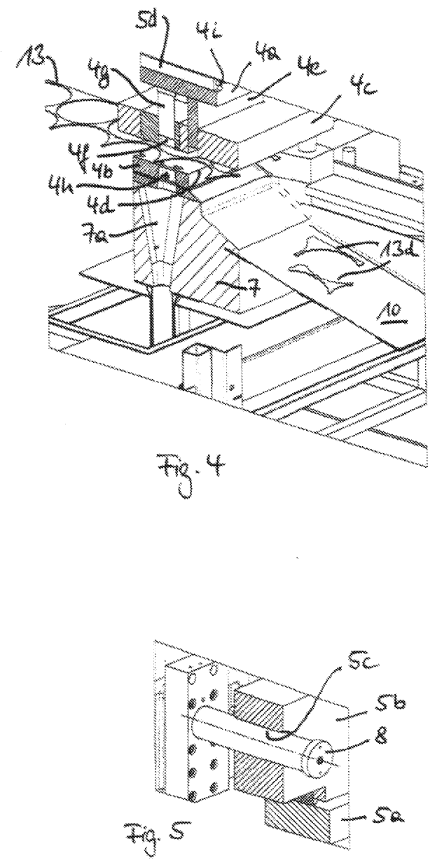

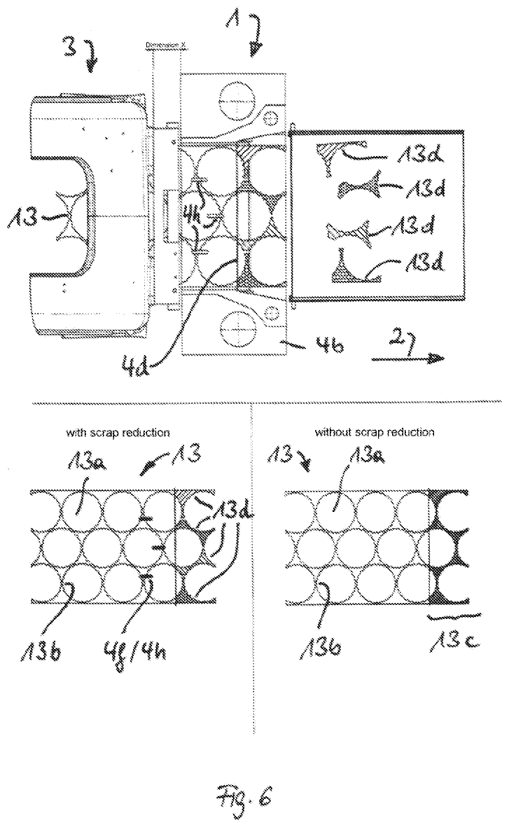

Here, FIGS. 1A and 1B shows a state in which a punching module 4 has not yet been inserted into the waste-cutting device 1. FIGS. 10, 3, 4 and 5 show a state in which the punching module 4 has been inserted, FIG. 2 show a punching-module support 14 and FIGS. 6 and 7 provide a visualization of the cutting-up according to the method of the punching scrap 13.

The waste-cutting device 1 comprises an upper support 5, which is formed here as two parts from the support elements 5a and 5b, a middle support 6 and a lower support 7. The upper support 5 has guide channels 5c which are extended through by guide rods 8 of the punching device 3. A stroke movement of the punching device 3 can be transmitted to the upper support 5 via the guide rods 8. Said supports 5, 6, and 7 are fastened to one another via linear guides 9 in such a way that the upper support 5 can move in a vertical direction in a defined manner relative to the lower support 7, in particular also to the middle support 6.

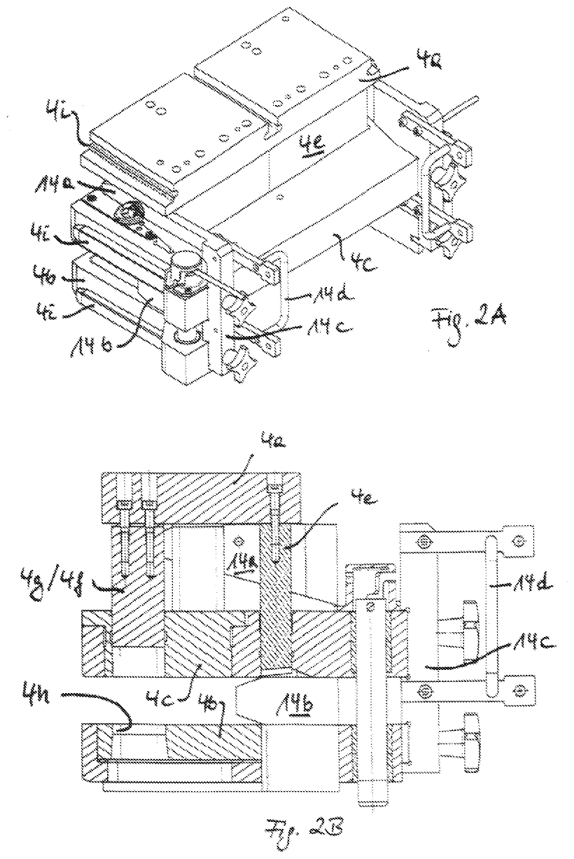

On the lower support 7, there is arranged a slide 10 via which punching-scrap portions subdivided according to the invention (not shown in FIGS. 1 and 4) can slide into the waste container 11.

Furthermore on the lower support 7, there are fastened two placement brackets 12 which are spaced apart perpendicularly to the running direction 2. It can be seen in FIG. 1 that the punching module 4 has been placed onto said placement brackets 12.

The punching module 4 comprises a knife unit 4a situated at the top, a cutting plate 4b situated at the bottom, and a slotted guide 4c situated therebetween. On the cutting plate 4b, there is arranged a cutting edge 4d which interacts with the cutting knife 4e of the knife unit 4a. Said cutting knife has a longitudinal extent which is perpendicular to the strip-running direction 2. The length of the cutting knife 4e in this direction is greater than the width of the sheet-metal strip, or punching scrap 13, to be cut up perpendicular to the running direction 2. Consequently, the punching scrap 13 is completely cut through by the cutting knife 4e.

In additional to the cutting knife 4e, the knife unit 4 also comprises multiple punches 4f, which are arranged on a common punch support 4g. Each punch 4f interacts with a die opening 4h in the cutting plate 4b. The die openings 4h open out downwardly into vertical channels 7a of the lower support, through which vertical channels parts punched out of punching-scrap webs can fall. Other than a technically necessary cutting gap, the contour of the die opening 4h is substantially identical in shape to the contour of the punch 4f. The shape of the piece punched out of the scrap web corresponds to the overlap of the shapes of scrap web 13b and die opening 4h.

The slotted guide 4c serves for guiding the cutting knife and the punches 4f or the punch support 4g.

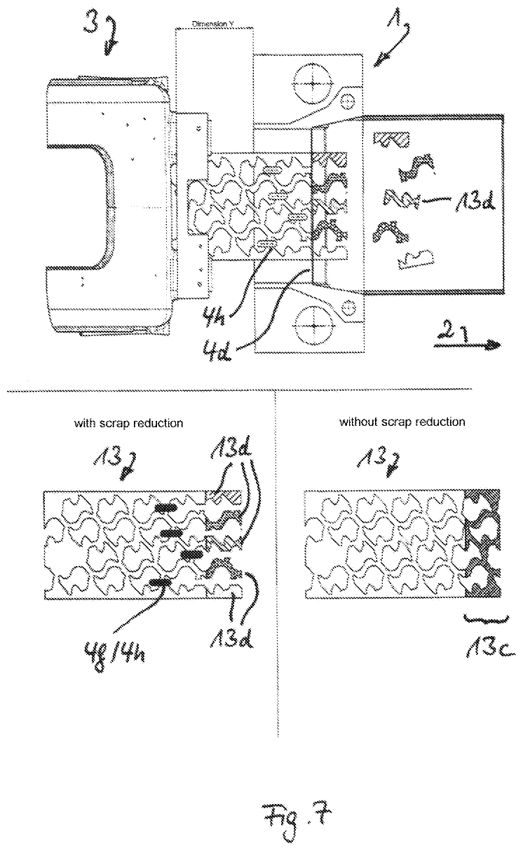

For fitting purposes, the punching module 4 can be fixed within itself by means of for example two punching-module supports 14 such that at least some of the elements of the punching module 4, preferably all the elements of the punching module 4, have a defined position, preferably a fixed, unchanging position, with respect to one another. FIG. 1B shows substantially the same view as FIG. 1A, albeit with two punching-module supports 14, which are fastened on the punching module 4 in order for at least some of the elements thereof, preferably all of the elements thereof, to be kept in the predetermined position with respect to one another for fitting purposes. After the fitting of the punching module 4 in the waste-cutting device 1, the punching-module supports 14 are removed from the punching module 4. FIG. 10 shows this state.

At least the knife unit 4a has, preferably on the upper plate thereof, two oppositely situated rail elements 4i which interact with corresponding rail elements 5d on the upper support, in particular in the sense that the knife unit can be pushed into the upper support so that the rail elements 4i, 5d are connected. The rail elements can be seen particularly in FIG. 2 and in FIG. 4. The cutting plate 4b and/or the slotted guide 4c may preferably likewise be connected by way of rail elements 4i in corresponding rail elements on the middle support 6.

FIGS. 2A and 2B show, in a perspective view and in section, the punching module 4 detached from the remaining elements of the waste-cutting device 1 in a state in which two punching-module supports 14 are fastened on the punching module 4. The punching-module supports 14 are preferably fastened at two oppositely situated side regions of the punching module 4 on the latter.

Each punching-module support 14 can preferably be connected, preferably fixedly connected, for example by screwing, to at least to a subset of all the elements of the punching module 4. It may be provided here that there is a screwed connection at least with respect to the cutting plate 4b and to the slotted guide 4c of the punching module 4. The cutting unit 4a can preferable bear on the punching-module supports 14 loosely, but nevertheless in a defined relative position with respect to the other elements 4b, 4c. Alternatively, a screwed connection with respect to the punching-module support 14 may also be provided in the case of the knife unit 4a.

Preferably, it is provided that a respective punching-module support 14 has at least one support 14a which extends in the pushing direction on the placement bracket 12, preferably two supports 14a, 14b which are situated one below the other and which each extend in the pushing direction and which are connected by a bridge element 14c. Such supports 14a, 14b may preferably narrow towards the free end. The supports may be pushed between the elements of the punching module 4 and keep these at a defined distance. For example, the upper support 14a may come to lie between knife unit 4a and slotted guide 4c and the lower support 14b may come to lie between cutting plate 4b and slotted guide 4c. The knife unit 4a, which can be moved relative to the slotted guide 4c, may bear loosely on the upper support 14a or else be screwed to the latter.

For better handling, grip elements 14d may be fastened on the punching-module supports 14.

FIGS. 6 and 7 provide a visualization of the procedure according to the method with two different examples.

Punching scrap 13 which, in the strip-running direction 2, runs from a punching device 3 and runs into the waste-cutting device 1 is illustrated in FIG. 6 at the top. The punching scrap 13 comprises substantially circular cutouts 13a, for example with boundary undulation. For example, such cutouts are formed during the manufacture of lamellar plates for automatic transmission of motor vehicles. The cutouts 13 are arranged offset from one another and are connected by scrap webs 13b.

According to the existing prior art, provision is made for the punching scrap to be completely cut through transversely, preferably perpendicularly, to the strip-running direction 2 along the cutting edge 4d by the cutting knife. In this way, cohesive punching-scrap portions 13c, which in FIGS. 6 and 7 correspond to the totality of all the hatched surface regions of the punching scrap 13b, would be formed.

According to the invention, by contrast, provision is furthermore made for punching-scrap webs 13b which form in the punching scrap 13 a connection between the boundaries thereof in the transverse direction to be cut through by punches 4f by the punches 4f at the respective location above the die openings 4h. This cutting-up results in a punching-scrap portion being reduced to the sub-portions 13d. This makes it possible to achieve a significantly higher packing density in the waste container 11.

Owing to the offset position of the punches 4f in the strip-running direction, said punches can be adapted well to the scrap-web positions.

The position of cutting knife 4e and punches 4f is preferably selected in such a way that the cutting knife 4e cuts the punching scrap 13 in a region with as small a proportion of material as possible, in particular at the location of the smallest proportion of material in the punching scrap (as viewed in the transverse direction), and each punch 4f cuts through a scrap web 13b, preferably which provides a transverse connection in the punching scrap 13.

FIG. 6 shows that the waste-cutting device 1 is arranged at a distance according to dimension X from the punching device 3.

FIG. 7 shows, in an application with different punching scrap 13, the distance between punching device 3 and waste-cutting device 1 with a dimension Y. In FIG. 6, use is made of four punches 4f instead of three punches 4f since, in comparison with FIG. 6, there are more transversely connecting webs 13b in the shown pattern of the punching scrap 13. In FIG. 7 too, all the punches 4f are at a different distance from the cutting knife 4e.

Distance variation can be realized by way of displacement between the guide rods 8 and the channels 5c at the upper support of the waste-cutting device 3.

1. A method for cutting up a punching scrap web running as waste from a punching device, comprising arranging a waste-cutting device after the punching device with respect to a running direction of the punching scrap web, providing the waste-cutting device with a cutting edge and a cutting knife configured to completely cut through the punching scrap web perpendicularly to the running direction thereof at the cutting edge by the cutting knife thereby to divide the punching scrap web into punching scrap portions and also providing the waste-cutting device with at least one punch spaced apart from the cutting knife and configured to cut through the punching scrap web at sites at which the punching scrap has not been punched through by the punching device whereby each of the punching-scrap portions is subdivided into at least two punching-scrap sub-portions.

2. The method according to claim 1, wherein the waste-cutting device is configured so that in successive strokes, firstly the punching scrap web is cut through by the at least one punch at sites at which the punching scrap has not been punched through by the punching device and subsequently the punching scrap web is completely cut through perpendicularly to the running direction at the cutting edge by the cutting knife.

3. The method according to claim 1, wherein the punching device is a press configured to effect a trim-in-place process in which one sheet metal piece or a plurality of sheet metal pieces are punched out of a metal sheet per stroke of the press and wherein a piece is punched out of the punching scrap web by the at least one punch during the trim-in-place process.

4. An apparatus comprising a punching device and a waste-cutting device configured to receive a punching scrap web from the punching device, the waste-cutting device comprising a cutting knife and a cutting edge configured so that the punching scrap web passes between the cutting knife and the cutting edge in a running direction of the punching scrap web and, by way of interaction of the cutting knife and the cutting edge during a stroke of the cutting knife, the punching scrap web is completely cut through perpendicularly to the running direction, and wherein the waste-cutting device further comprises, spaced apart from the cutting knife in the running direction at least one punch arranged in a fixed location relative to the cutting knife and configured to be moved together with the cutting knife to cut through the punching scrap web at sites at which the punching scrap has not been punched through by the punching device.

5. The apparatus according to claim 4, wherein the at least one punch is arranged before the cutting knife in the running direction of the punching scrap web.

6. The apparatus according to claim 4, further comprising a punch support and wherein the at least one punch comprises at least two punches, and wherein the at least two punches are arranged on a common punch support and the punch support extends parallel to the cutting knife at a distance therefrom.

7. The apparatus according to claim 4, wherein the at least one punch comprises at least two punches which are arranged spaced apart from one another in a direction of extent of the cutting knife.

8. The apparatus according to claim 7, wherein at least one of the punches is at a different distance from the cutting knife than the at least one other of the punches.

9. The apparatus according to claim 4, wherein the waste-cutting device further comprises
a. a lower support,
b. an upper support configured to be coupled kinematically to the punching device so that a stroke movement relative to the lower support can be performed, and
c. an exchangeable punching module comprising a knife unit connected to or configured to be connected to the upper support and on which the cutting knife and the at least one punch are arranged, and a cutting plate connected to or configured to be connected to the lower support and on which the cutting edge configured to interact with the cutting knife and at least one die opening each of which is configured to interact with a respective one of the at least one punch are arranged.

10. The apparatus according to claim 9, wherein the knife unit and the upper support have interacting rail elements configured so that the knife unit is or can be pushed into the upper support.

11. The apparatus according to claim 9, wherein the waste-cutting device further comprises a middle support on which a slotted guide of the punching module is fastened or which is configured so that the slotted guide of the punching module can be fastened thereon, the slotted guide being configured to guide the cutting knife and the at least one punch or the punch support.

12. The apparatus according to claim 9, wherein the waste-cutting device further comprises at least one punching-module support each configured to position at least some elements of a respective one of the at least one punching module at least temporarily in fixed positions relative to one another, each of the at least one punching-module support being configured so that the punching module can, whole as a unit, be inserted into the waste-cutting device and be removed therefrom.

13. The apparatus according to claim 9, wherein the waste-cutting device further comprises two spaced-apart placement brackets which are configured to be removably arranged above a waste slide and so that the punching module can be placed thereon and displaced therefrom.

14. The apparatus according to claim 9, wherein the upper support has two spaced-apart guide channels configured so that the upper support can be pushed onto respective guide rods of the punching device by means of which the upper support can be moved by the punching device during a stroke of the latter.

15. The method according to claim 1, wherein the punching device is a fine blanking press.

16. The method according to claim 1, wherein the at least one punch comprises at least two punches.

17. The apparatus according to claim 4, wherein the punching device is a fine blanking press.

18. The apparatus according to claim 8, wherein the at least two punches comprise at least three punches.

19. The apparatus according to claim 10, wherein the interacting rails are configured so that a direction in which the cutting knife is pushed or is configured to be pushed into the upper support is in the running direction of the punching scrap web or perpendicular to a direction of extent of the knife.
